(19) United States
(12) Patent Application Publication
(10) Pub. No.: US 2013/0129178 A1
(43) Pub. Date: May 23, 2013

(54) METHOD AND SYSTEM FOR ITERATIVE IMAGE RECONSTRUCTION

(71) Applicant: Herfried Karl Wieczorek, Aachen (DE)

(72) Inventor: Herfried Karl Wieczorek, Aachen (DE)

(73) Assignee: KONINKLIJKE PHILIPS ELECTRONICS N.V., EINDHOVEN (NL)

(21) Appl. No.: 13/813,714

(22) PCT Filed: Jul. 18, 2011
(86) PCT No.: PCT/IB11/53182

§ 371 Date: Feb. 1, 2013

Related U.S. Application Data
(60) Provisional application No. 61/370,575, filed on Aug. 4, 2010.

(51) Int. Cl. G06T 7/00

(52) U.S. Cl. CPC G06T 7/0012
USPC 382/131

(57) ABSTRACT

A method includes reconstructing projection data corresponding to a scanned object of interest using an iterative reconstruction algorithm in which a number of reconstruction iterations for the iterative reconstruction algorithm is set based on a size of the scanned object of interest. A system (114) includes a reconstruction algorithm bank (210) including at least one iterative reconstruction algorithm (210), a number of reconstruction iteration determiners (208) that determines a number of reconstruction iterations for reconstructing an image of a scanned object of interest based on the at least one iterative reconstruction algorithm for a size of the scanned object of interest, and a reconstructor (112) that reconstructs projection data to generate the image using at least one iterative reconstruction algorithm based on the determined number of reconstruction iterations.

### DESCRIPTION

The following generally relates to image reconstruction and is described with particular application to iterative reconstruction for Computed Tomography (CT). However, the following is also amenable to other imaging modalities.

Iterative reconstruction algorithms such as Maximum Likelihood Expectation Maximization (MLEM) and Ordered Subset Expectation Maximization (OSEM) statistical based reconstruction algorithms have been used to reconstruct images for imaging modalities such as Positron Emission Tomography (PET) and Single Photon Emission Computed Tomography (SPECT). Such reconstruction algorithms are well-suited for nuclear medicine applications due to the low spatial resolution and small reconstruction volumes and, hence, low number of voxels in the image volume to be reconstructed. These algorithms take the statistical nature of the data generated in PET and SPECT imaging into account and provide images with a lower noise level than analytic reconstruction methods like filtered back-projection (FBP). FBP has been the standard reconstruction approach in Computed Tomography (CT). However, the literature has proposed using iterative reconstruction algorithms to reconstruct images in CT, for example, for low dose protocols.

Generally, with an iterative reconstruction algorithm, the quality of the reconstructed images depends strongly on the number of iterations and subsets used. For example, a lower number of iterations generally does not recover higher spatial frequencies in the image like a higher number of iterations, and a higher number of iterations increases the noise level in the image relative to a lower number of iterations. Furthermore, the literature has provided that statistical reconstruction algorithms result in a lower modulation transfer function (MTF) and lower noise for larger objects relative to smaller objects given the same number of iterations for reconstructing both the larger and the smaller objects. Unfortunately, reconstruction is usually performed based on standard parameters. As a consequence, reconstructed images are far from optimized, with a higher than necessary noise level for small objects and insufficient spatial resolution for larger objects.

Aspects of the present application address the above-referenced matters and others.

According to one aspect, a method includes reconstructing projection data corresponding to a scanned object of interest using an iterative reconstruction algorithm in which a number of reconstruction iterations for the iterative reconstruction algorithm is set based on a size of the scanned object of interest.

According to another aspect, a system includes a reconstruction algorithm bank including at least one iterative reconstruction algorithm, a number of reconstruction iteration determiners that determines a number of reconstruction iterations for reconstructing an image of a scanned object of interest based on the at least one iterative reconstruction algorithm for a size of the scanned object of interest, and a reconstructor that reconstructs projection data using at least one iterative reconstruction algorithm to generate the image based on the determined number of reconstruction iterations.

According to another aspect, a computer readable storage medium encoded with instructions which, when executed by a processor of a computer, cause the processor to identify a number of iterations for an iterative reconstruction of projection data for a scanned object of interest based on a size of a scanned object of interest.

The invention may take form in various components and arrangements of components, and in various steps and arrangements of steps. The drawings are only for purposes of illustrating the preferred embodiments and are not to be construed as limiting the invention.

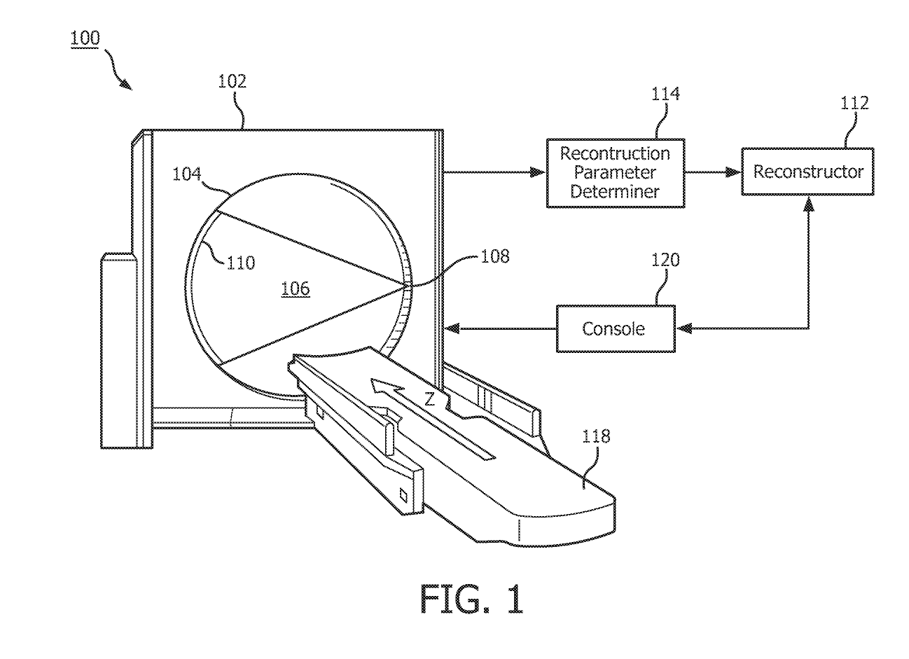

FIG. 1 illustrates an example imaging system.

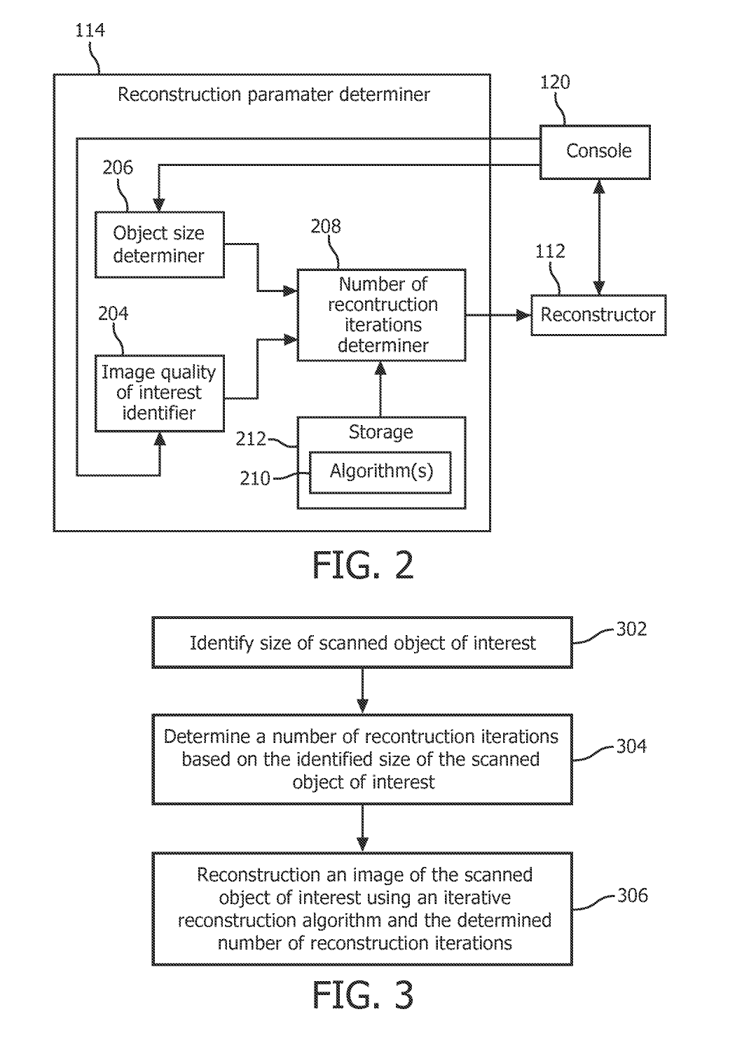

FIG. 2 illustrates an example reconstruction parameter determiner

FIG. 3 illustrates an example method.

FIG. 1 illustrates an imaging system 100 such as a computed tomography (CT) scanner. In other embodiments, the imaging system 100 includes a SPECT, SPECT/CT, SPECT/MR, PET, PET/CT, PET/MR, CT, Flat panel CT (Volume Imaging) with iterative reconstruction, and/or other scanner.

The imaging system 100 includes a stationary gantry 102 and a rotating gantry 104, which is rotatably supported by the stationary gantry 102. The rotating gantry 104 rotates around an examination region 106 about a longitudinal or z-axis. A radiation source 108, such as /an x-ray tube, is supported by the rotating gantry 104 and rotates with the rotating gantry 104, and emits radiation. A radiation sensitive detector array 110 located opposite the source 108 detects radiation that traverses the examination region 106 and generates projection data indicative thereof. The radiation sensitive detector array 110 may include one or more rows of radiation sensitive pixels elements.

A reconstructor 112 reconstructs projection data based on one or more reconstruction algorithms, such as an iterative statistical or other reconstruction algorithm, which can be obtained from a local or remote storage device. The reconstructor 112 reconstructs projection data and generates volumetric image data indicative of the examination region 106. A reconstruction parameter determiner 114 determines one or more reconstruction parameter for the reconstructor 112. As described in greater detail below, in one instance, the reconstruction parameter determiner 114 determines a number of reconstruction iterations for reconstructing projection data for a scanned object of interest, for a given modulation transfer function (MTF), based on a size of the scanned object of interest. The reconstructor 112 employs the determined number of reconstruction iterations to reconstruct the projection data and generate an image of the scanned object of interest. Such a reconstruction may ensure a predetermined image quality, for example, in terms of MTF and an as low as possible noise level, by adapting the reconstruction parameters to the size of the scanned object.

A support 118, such as a couch, supports a subject in the examination region 106. The support 118 can be used to variously position the subject with respect to x, y, and/or z axes before, during and/or after scanning. A general purpose computing system serves as an operator console 120, which includes human readable output devices such as a display and/or printer and input devices such as a keyboard and/or mouse. Software resident on the console 120 allows the operator to control the operation of the system 100, for example, allowing the operator to select a reconstruction algorithm (e.g., an iterative statistical reconstruction algorithm), facilitate determining and/or setting reconstruction parameters (e.g., number of reconstruction iterations), initiate scanning, etc.

It is to be appreciated that the reconstruction parameter determiner 114 may be or may not be part of the console 120, the reconstructor 112, another component of the imaging system 100, and/or an apparatus remote from the system 100. It is also to be appreciated that the reconstruction parameter determiner 114 may include or be implemented by one or more processors that execute one or more computer readable instructions embedded and/or encoded on computer readable storage medium and/or transitory computer readable signal medium.

FIG. 2 illustrates an example reconstruction parameter determiner 114.

The reconstruction parameter determiner 114 includes an image quality of interest identifier 204. In one instance, the image quality of interest identifier 204 identifies an image quality of interest for a study based on the scan protocol for the study, an input (e.g., a user input) indicative of a particular image quality, and/or otherwise. The image quality of interest identifier 204 generates a signal indicative of the determined image quality of interest. Examples of suitable image quality parameters include, but are not limited to, a modulation transfer function (MTF), signal power spectrum, noise level, noise variance, etc.

By way of non-limiting example, the console 120, via an executing scanning application, may present, via a graphical user interface, user selectable options such as “soft contours with low noise,” “enhanced contours with increased noise,” or “heavily iterated for quantitative evaluation with high noise,” and selecting one of the options automatically selects the image quality parameters defined for the option. In another instance, the user manually enters parameters and/or selects from one or more other options and/or predefined protocols. The generated signal includes information indicative of the selected parameters.

An object size determiner 206 determines a size of the scanned object of interest in the transaxial plane perpendicular to the longitudinal or z-axis of the imaging system. In the illustrated embodiment, the object size determiner 206 determines a diameter (or average diameter) of the scanned object of interest in terms of a number of voxels spanning the diameter or other length based on the voxel size for the study, which may be obtained from a selected scan protocol or otherwise. The object size determiner 206 generates a signal indicative of the determined size of interest.

In the illustrated embodiment, the object size determiner 206 estimates the object size based on an image reconstructed after a predetermined number of iterations, which is less than the number of iterations the total number of iterations used to reconstruct the image. In another embodiment, the object size determiner 206 estimates the object size based on a pre-reconstructed image, for example, using a FBP reconstruction algorithm or other reconstruction algorithm to reconstruct an image of the scanned object of interest.

Alternatively, the object size determiner 206 determines the object size based on a user input. By way of non-limiting example, the console 120 may present user selectable options such as “thin man’,” or “fat man,” and selecting one of the options automatically selects one of two predefined object sizes, and the generated signal includes information indicative of the selected object size.

A number of reconstruction iterations determiner 208 can variously determine a number of reconstruction iterations for the reconstructor 112 based on the signal indicative of image quality and the signal indicative of the determined size of interest. The illustrated number of iterations determiner 208 determines the number of reconstruction iterations based on one or more algorithms 210 in a storage component 212. The number of iterations determiner 208 generates a signal indicative of the determined number of reconstruction iterations for the study.

In one embodiment, the number of iterations determiner 208 provides the signal to the reconstructor 112, which reconstructs the data based on the signal. In another embodiment, the number of iterations determiner 208 provides the signal to the console 120, which presents or suggest a number of iterations. The user can then confirm, change, and/or reject the number iterations.

In one instance, determining the number of reconstruction iterations for a given study as such allows for optimizing or setting a reconstruction noise level of interest for a given MTF for different sized objects. Reconstruction parameters such as the number of iterations can then be set proportional to the average object diameter and inversely proportional to the voxel size, and automatically employed or presented to a user .

FIG. 3 illustrates an example method. It is to be understood that the order of the following acts is not limiting. In other embodiments, one or more of the following may occur in a different order, including concurrently. Furthermore, in another embodiment, one or more of the below acts may be omitted and/or one or more other acts may be added.

At 302, a scanned object size of interest is identified for the study. As discussed therein, the size may be determined based on a selected scan protocol, from an image generated after a few iterations, from an image reconstructed using FBP, and/or otherwise.

At 304, a number of reconstruction iterations is determined for an iterative reconstruction of the projection data for the scanned object of interest based on the object size.

At 306, the projection data for the scanned object of interest is reconstructed using an iterative reconstruction algorithm and the identified number of reconstruction iterations.

The above described acts may be implemented by way of computer readable instructions, which, when executed by a computer processor(s), causes the processor(s) to carry out the acts described herein. In such a case, the instructions are stored in a computer readable storage medium such as memory associated with and/or otherwise accessible to the relevant computer.

As noted above, the number of iterations determiner 208 can variously determine a number of reconstruction iterations for the reconstructor 112 via the algorithms 210. An example of a suitable algorithm and the underlying theory is described in Wieczorek, “Image quality of FBP and MLEM reconstruction,” Phys. Med. Biol. 55 (2010) 3161-3176 and below:

Image quality measures are discussed below based on a transaxial slice of thickness p out of a phantom and a measurement of the radiation from this slice with a detector. For this example, the average number of counts per detector pixel is n_{b}=A_{b}TE for the background and nₗ=A₁TE for a lesion, with A_{b} and Aₗ the respective activity values per voxel, T the imaging time and E the detector efficiency. The measured contrast can be represented as shown in Equation 1:

C₀=(nᵢ−n_{b})/n_{b}=(Aₗ−A_{b})/A_{b}, Equation 1:

wherein the index ‘0’ denoting values for the cut-out slice. For Poisson like count statistics noise is given by the standard deviation σ=\sqrt{n_{b}} and the background signal-to-noise ratio can be represented as shown in Equation 2:

SNR₀=n_{b}/σ=\sqrt{A_{b}TE}. Equation 2:

Detectability of lesions has been specified by the Rose criterion stating that the contrast-to-noise ratio CNR=ΔS/N has to be larger than a value of approximately five, with the lesion signal ΔS defined as the difference between lesion and background integrated over the lesion area, ΔS=(nᵢ−n_{b})·rᵢ²π, and N given by background noise integrated over an equivalent area, N=\sqrt{n_{b}·rᵢ²π}. The contrast-to-noise ratio can be represented as shown in Equation 3:

CNR₀=C₀\sqrt{A_{b}TE·rᵢ²π}. Equation 3:

These standard image quality measures, SNR and CNR, describe noise level and lesion detectability but they do not provide any information about noise texture or spatial frequency dependence of signal and noise. For this reason we introduce the DQE image quality concept.

The spectral information content and noise level of an image can be expressed in terms of signal and noise power spectra, SPS and NPS. These power spectra are locally defined since the properties of reconstruction depend on the position in the image and the surrounding activity. In this example of reconstruction image quality, signal and noise power spectra are measured at the edge of the lesion and in the centre of the reconstructed phantom image, respectively.

Noise Power Spectra can be extracted by Fourier analysis of the central part of a homogeneous phantom. This can be done for a 16×16 pixel region centered in the standard phantom without lesion by applying a one-dimensional Fourier transform on 16 rows with their respective mean values subtracted and taking the average of the squared moduli to generate the noise power spectra. For discrete sampling spectra can defined in the spatial frequency range −1/2p . . . 1/2p, where p is the sampling interval of the projections, equal to the voxel size of the reconstructed image matrix. The spatial frequency k can be written in units of cycles per pixel, resulting in the frequency interval −0.5 . . . 0.5. Due to the symmetry of the spectra it is sufficient to show the positive part of the spatial frequency axis, leaving out values for k=0 that cannot be measured on a phantom of limited size. By definition the integral of the NPS is equal to the background variance of the image as shown in Equation 4:

$${\int }_{- 0.5}^{+ 0.5} NPS ( k ) d k = {σ}^{2} . \qquad Equation 4$$

The ensemble variance σ² can be evaluated directly from the distribution of pixel values in the phantom center. For inhomogeneous phantoms, especially in case of iterative reconstruction with a low number of iterations, the reconstructed images can be regularized by subtraction of a noise-free realization of the same image.

Signal Power Spectra can be derived by Fourier transformation of a point source image or a differentiated step function. Here, the lesion edge is differentiated in a noise free image along one of the detector axes, and a one-dimensional Fourier transform is applied on 16 data values and the moduli are squared to get the signal power spectra. The zero frequency value of the SPS is equal to the step height at the lesion edge given by SPS(0)=C₀·A_{b}TE.

To adjust the signal and noise power spectra to the same signal height, a lesion with a contrast C=1 is employed in this example. The square root of the normalized SPS function, independent of contrast or background level, is better known as the modulation transfer function MTF, and SPS can be represented as shown in Equation 5:

SPS(k)=MTF²(k)·A_{b}TE. Equation 5:

Detective quantum efficiency describes the deterioration of the number of noise equivalent quanta (NEQ), given by the squared signal-to-noise ratio, by any detection or conversion process. For a random variable with Poisson distribution the general DQE is defined as the ratio of the NEQ after and before the process and interpreted as a reduction in the number of statistically relevant detected quanta. Application of the DQE concept to reconstruction means comparing reconstructed slices with the theoretically available information from the same slices cut out of the phantom. The general DQE for ideal SPECT can be represented as shown in Equation 6:

DQE=SNR_{R}²/SNR₀²=A_{b}TE/94 ². Equation 6:

More specific information about the signal transfer and noise properties of a system may be provided by the frequency dependent DQE function, defined as ratio of the noise power spectra before and after reconstruction, with the latter divided by the squared MTF to account for the impact of spatial resolution on the visibility of objects, as shown in Equation 7:

DQE(k)=MTF²(k)·NPS₀(k)/NPS_{R}(k)=SPS(k)/NPS(k) . Equation 7:

The equivalence of the two forms of this definition is obvious since the noise power spectrum measured on a cut-out transaxial slice shows white noise given by NPS₀(k)=A_{b}TE. In case of white system noise there is a natural relation between the general and frequency dependent form of the DQE: The low-frequency limit of DQE(k) is equal to the general DQE.

When radiation from the contrast phantom is measured by the detector in a lateral view we get an average number of counts per pixel p_{b}=A_{b}TE·d_{b} in the central part of the phantom projection. The difference between projected lesion and background is pₗ−p_{b}=C₀·A_{b}TE·2rₗ so that contrast in an ideal projection, denoted by the index ‘IP’, is strongly reduced in comparison to the phantom contrast represented in Equation 8:

C_{IP}=(pₗ−p_{b})/P_{b}=C₀·rₗ/r_{b}. Equation 8:

The signal-to-noise ratio of the planar image is increased especially for large phantoms, as shown in Equation 9:

SNR_{IP}=SNR₀·\sqrt{d_{b}}, Equation 9:

and the contrast-to-noise ratio depends on the relative size of phantom and lesion, as shown in Equation 10:

CNR_{IP}=(C₀A_{b}TE·4/3·rᵢ³π)·(A_{b}TE·2r_{b}rₗ²π)^{-1/2}≈CNR₀·r₁(r_{b})^{-1/2}. Equation 10:

Transaxial phantom slices can be reconstructed from m projections acquired under different viewing angles within the total imaging time T. A detector pixel viewing the central part of the phantom without lesion measures an average number of counts P_{b}=A_{b}TE·d_{b}/m with standard deviation \sqrt{P_{b}} in each projection. In filtered back-projection the signal on all detector pixels is backprojected and spatially filtered by a function q(t) so that the number of detected counts per voxel is restored to n_{IR}=A_{b}TE.

During reconstruction, noise is added up on all voxels along the lines of back-projection. Summing m projections with equal standard deviation into one voxel renders Equation 11:

$$σ = \sqrt{{mp}_{b} Q} = \sqrt{{A}_{b} TE \cdot {d}_{b} \cdot Q} , \\ Q = {π}^{2} {\int }_{- 0.5}^{+ 0.5} {\vert Q ( k ) \vert}^{2} d k , \qquad Equation 11$$

with the parameter Q defined by integrating the filter function in Fourier space.

The signal-to-noise ratio of images reconstructed from ideal projections, denoted by index ‘IR’, is reduced by the square root of the number of voxels per phantom diameter, as shown in Equation 12:

SNR_{IR}=n _{IR}/σ=SNR₀·(d_{b}Q)^{-1/12}. Equation 12:

Contrast C_{IR} is identical to that in the original phantom contrast C₀, and for the contrast-to-noise ratio we get the same phantom size dependence as for the SNR, as shown in Equation 13:

CNR_{IR}=CNR₀·(d_{b}·Q)^{-1/2}. Equation 13:

From Equation 12, the general DQE value for filtered back-projection can be written as shown in Equation 14:

DQE=SNR_{R}²/SNR₀²=(d_{b}·Q)⁻¹. Equation 14:

Signal power spectra are calculated from Equation 5 with the MTF given by the filter function A(k) in Fourier space, multiplied by the intrinsic filter function Fₗᵢₙₑₐᵣ(k) for linear interpolation, and can be represented as shown in Equation 15:

SPSₙₑₐᵣₑₛₜ(k)=A_{b}TE·|A(k)|², SPSₗᵢₙₑₐᵣ(k)=A_{b}TE·|A(k)|²·Fₗᵢₙₑₐᵣ(K) Equation 15:

Noise power spectrum is given by NPS(θ,k)=p₀·|Q(k)|²/k with the projection p₀ for the continuous case. Changing to discrete coordinates with projections p_{b} and scaling by a factor it renders Equation 16:

PS(θ,k)=p_{b}m·π|Q(k)|²/k, Equation 16:

which by integration gives the Expression 11 for the variance in the reconstructed image,

$$\begin{matrix}{σ}^{2} = {\int }_{0}^{π} {\int }_{- 0.5}^{+ 0.5} N P S ( θ , k ) \cdot k d k d θ \\ = {p}_{b} m \cdot {π}^{2} {\int }_{- 0.5}^{+ 0.5} {\vert QK \vert}^{2} d k \\ = {A}_{b} TE {d}_{b} \cdot Q .\end{matrix}$$

For an assessment of image quality, the power spectra can be analyzed in Cartesian coordinates anywhere in the reconstructed image instead of an analysis in radial direction at the origin. For this conversion of coordinates we divide by the spatial frequency k so that the noise power spectra are proportional to |A(k)|². For a one-dimensional spectrum, the power spectra can be represented as shown in Equation 17:

$$N P S ( {k}_{x} ) = {A}_{b} TE {d}_{b} Q \cdot {\vert A ( {k}_{x} ) \vert}^{2} / {A}_{filter} , \\ {A}_{filter} = {\int }_{- 0.5}^{+ 0.5} {\vert A ( k ) \vert}^{2} d k . \qquad Equation 17$$

In this example, linear interpolation in the noise power calculation is not accounted for since the slight spatial shift caused by linear interpolation does not change the signal level of the back-projected data and has no impact on noise properties. From Equations 15 and 17, the DQE spectra for nearest neighbor and linear interpolation can be expressed as shown in Equation 18:

$${DQE}_{nearest} ( {k}_{x} ) = \frac{{A}_{filter}}{{d}_{b} {Q}_{nearest}} , \\ {DQE}_{linear} ( {k}_{x} ) = \frac{{A}_{filter} {F}_{linear} ( k )}{{d}_{b} {Q}_{linear}} . \qquad Equation 18$$

For nearest neighbor interpolation, DQEₙₑₐᵣₑₛₜ=0.024, 0.03, 0.062 and 0.10 for the four filters shown above, and the zero-frequency limits of _{DQE}ₗᵢₙₑₐᵣ are 0.051, 0.058, 0.093 and 0.135.

Statistical reconstruction algorithms have been preferred over analytic reconstruction methods like FBP. Such algorithms allow for suppression of artifacts, better noise performance, and, as for iterative reconstruction methods, the possibility to correct for absorption, spatial resolution and scatter. Common algorithms are the Maximum Likelihood Expectation Maximization (MLEM), Ordered Subset Expectation Maximization (OSEM), and/or other algorithms.

MLEM calculates the most probable activity distribution in the object from the emission pattern seen in the SPECT projections. The algorithm is implemented in two steps, the forward projection of an assumed activity distribution on the detector and the back-projection providing correction factors used in the subsequent update of the assumed distribution, as shown in Equation 19:

$${λ}_{i}^{( n + 1 )} = {λ}_{i}^{( n )} \cdot \frac{1}{{\sum }_{j ɛ J} {f}_{ij}} {\sum }_{j ɛ J} \frac{{p}_{j}}{{\sum }_{k ɛ I} {f}_{kj} {λ}_{k}^{( n )}} \cdot {f}_{ij} . \qquad Equation 19$$

Thus, the (n+1)-th estimate λᵢ⁽ⁿ⁺¹⁾ is based on the n-th estimate λᵢ⁽ⁿ⁾ of the mean emission rate of voxel i multiplied by a corrective term which is back-projected and normalized using the factors fᵢⱼ. This term is calculated from all detector pixels and projections j by the ratio of measured projection data pⱼ and the forward projection of the former estimate on the detector,

$${\sum }_{k ɛ I} {f}_{kj} {λ}_{k}^{( n )} .$$

In ideal SPECT, fᵢⱼ=1/m is the element of the normalized system matrix for a voxel i near the centre of the phantom with the respective detector element j, rendering Equation 20:

$${λ}_{i}^{( n + 1 )} = {λ}_{i}^{( n )} \cdot {\sum }_{j ɛ J} ( {p}_{j} / {\sum }_{k ɛ I} {λ}_{k}^{( n )} ) . \qquad Equation 20$$

Reconstruction can be initiated with a homogeneous activity distribution λᵢ⁽⁰⁾=1. Since the image volume is rotated during reconstruction, its effective diameter is equal to the voxel matrix size s under all projection angles. Setting pⱼ=A_{b}TEd_{b}/m renders Equation 21:

$${λ}_{i}^{( 1 )} = {\sum }_{j ɛ J} {p}_{j} / s , {σ}^{( 1 )} = \sqrt{{mp}_{j}} / s = \sqrt{{A}_{b} TE {d}_{b}} / s , \qquad Equation 21$$

for a voxel near the centre of the reconstructed phantom. The signal-to-noise ratio can be represented as shown in Equation 22:

SNR⁽¹⁾=λ⁽¹⁾/σ⁽¹⁾=SNR₀·\sqrt{d_{b}}, Equation 22:

after one MLEM iteration is much higher than for FBP.

A contrast-to-noise ratio can barely be defined in the indistinct reconstructed image after a few iterations. For subsequent iterations we have to consider the noise factors given by the product of terms in Equation 20. Assuming that at least for the first iterations the noise contribution of the denominator is negligible, approximately the same term is multiplied to the current estimate in every iteration as shown in Equation 23:

$$\begin{matrix}{λ}_{i}^{( n + 1 )} = {λ}_{i}^{( n )} \cdot {\sum }_{j ɛ J} \frac{{p}_{j}}{( {A}_{b} TE {d}_{b} )} \\ = \frac{1}{{s ( {A}_{b} TE {d}_{b} )}^{n}} \cdot {( {\sum }_{j ɛ J} {p}_{j} )}^{n + 1} ,\end{matrix} \qquad Equation 23$$

with the bracket in the denominator showing the approximation of the summed voxel values on the phantom diameter.

Using the formula for the relative error of the power of a term these approximated values cancel out renders Equation 24:

$$\frac{{σ}^{( n + 1 )}}{{λ}^{( n + 1 )}} = {\sqrt{[ ( n + 1 ) \frac{{σ}^{( 1 )}}{{λ}^{( 1 )}} ]}}^{2} = ( n + 1 ) . \sqrt{\frac{1}{{A}_{b} TE {d}_{b}}} . \qquad Equation 24$$

The signal-to-noise ratio is the inverse of the relative standard deviation and is thus inversely proportional to the number of iterations and can be represented as shown in Equation 25:

SNR⁽ⁿ⁾=λ⁽ⁿ⁾/σ=SNR₀·\sqrt{d_{b}}/n. Equation 25:

The noise model shows that the relative standard deviation of MLEM reconstruction is proportional to the number of iterations. For higher iteration numbers a slower increase of the noise has previously been reported. This can be explained by correlation of the noise in the denominator and numerator of Equation 23, yielding an effectively lower power in this equation. From Equations 6 and 25, the general DQE for MLEM with n iterations can be represented as shown in Equation 26:

DQE=A_{b}TE/σ⁽ⁿ⁾^{²}=d_{b}/n². Equation 26:

Equations 14 and 26 may indicate a fundamentally different dependence of FBP and OSEM on the object diameter, however, the object size dependence is substantially the same for both reconstruction techniques for a given constant signal transfer function: It has been shown in literature that the number of iterations necessary to obtain identical Signal Power Spectra for objects of different size is proportional to the diameter of the object. Using this proportionality of n and d_{b} it can be seen from Equation 26 that the DQE has a 1/d_{b} dependence just as in Equation 14.

The noise model shows that for iterative reconstruction optimized image quality, with a noise level linearly dependent on the diameter of the object just as with non-iterative reconstruction methods like FBP, is only obtained when the number of iterations is adapted to the size of the object being imaged. It should be appreciated that this holds for all sorts of iterative reconstruction, including corrective measures like the correction for absorption, scatter, and the like, and the use of filters during the iterative reconstruction and/or post-reconstruction.

The above has been described in connection with CT and SPECT for sake of brevity and explanatory purposes. However, it is to be understood that other imaging modalities are also contemplated herein. For example, the imaging system 100 may alternatively include SPECT, SPECT/CT, SPECT/MR, PET, PET/CT, PET/MR, CT, Flat panel CT (Volume Imaging) with iterative reconstruction, and/or other imaging modality in which images can be reconstructed from with iterative statistical reconstruction algorithm. For time-of-flight (TOF) PET the size of the reconstructed area is given by the coincidence time resolution, which has been around 75 mm for 500 ps resolution, and the parameters can be defined at the time of selecting a TOF-PET reconstruction.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A method, comprising:
reconstructing projection data corresponding to a scanned object of interest using an iterative reconstruction algorithm in which a number of reconstruction iterations for the iterative reconstruction algorithm is set based on a size of the scanned object of interest.

2. The method of claim 1, wherein the size is indicative of a number of voxels spanning a predetermined region of the scanned object of interest,

3. The method of claim 1, further comprising:
determining the size based on as representation of the object of interest in a image reconstructed after a predetermined sub-set of reconstruction iterations of the iterative reconstruction algorithm.

4. The method of claim 1, further comprising:
determining the size based on a representation of the object of interest in a image reconstructed using a non-iterative reconstruction algorithm.

5. The method of claim 1, further comprising:
determining an image quality for the iterative reconstruction,

6. The method or claim 5, wherein the number of iterations is determined based on the image quality,

7. The method of claim 1, further comprising:
determining the size based on a default size defined for the imaging protocol used to scan the object of interest.

8. The method of claim 1, wherein the number of iterations is determined for at least one of a given modulation transfer function or power spectrum.

9. The method of claim 1, wherein the number of iterations is proportional to the size of the object

10. The method of claim 1 further comprising:
presenting the number of iterations; and
employing the presented number of iterations to reconstruct the projection data in response to a user input accepting the number of iterations.

11. A system, comprising:
storage including at least one iterative reconstruction algorithm;
a number of reconstruction iteration determiners that determines a number of reconstruction iterations for reconstructing an image of a scanned object of interest based on the at least one iterative reconstruction algorithm for a size of the scanned object of interest; and
a reconstructor that reconstructs projection data using at least one iterative reconstruction algorithm to generate the image based on the determined number of reconstruction iterations.

12. The system of claim 11, further comprising:
an object of interests size determiner that determines the size of the object based on an image generated using a non-iterative reconstruction algorithm,

13. The system of claim 11₄ further comprising:
an object of interests size determiner that determines the size of the object based on an image generated after a sub-set of the reconstruction iterations.

14. The system of claim 11, further comprising:
an object of interests size determiner that determines the size of the object based on a default size corresponding to an imaging protocol for the study.

15. The system of any of claim 11, wherein the size represents a number of voxels spanning a predetermined region of the object.

16. The system of claim 11, further comprising:
an image quality determiner that determines an image quality for the iterative reconstruction.

17. The system of claim 17, wherein the number of iterations is determined based on the image quality.

18. The system of claim 17, wherein the image quality includes at least one of a modulation transfer function or a power spectrum.

19. A computer readable storage medium encoded with computer executable instructions, which, when executed by a processor of a computer, cause the processor to: identify a number of iterations for an iterative reconstruction of projection data for a scanned object of interest based on a size of the scanned object of interest.

20. The computer readable storage medium of claim 19, wherein the computer executable instructions, which, when executed by the processor of the computer, further cause the processor to: reconstruct an image of the scanned object of interest based on the iterative reconstruction and the number of iterations for the iterative reconstruction algorithm,
